(19) United States
(12) Patent Application Publication
(10) Pub. No.: US 2014/0136360 A1
(43) Pub. Date: May 15, 2014

(54) ECONOMIC DECISION SYSTEM FOR CONSUMPTION OF SECURITY SERVICES IN CLOUD ENVIRONMENTS

(71) Applicant: Andreas Schaad, Karlsruhe (DE)

(72) Inventor: Andreas Schaad, Karlsruhe (DE)

(73) Assignee: SAP AG

(21) Appl. No.: 13/672,990

(22) Filed: Nov. 9, 2012

(51) Int. Cl. G06Q 30/06

(52) U.S. Cl. CPC G06Q 30/0631
USPC 705/26.7

(57) ABSTRACT

Implementations of the present disclosure include methods, systems, and computer-readable storage mediums for recommending one or more security services to be consumed by an enterprise operator, the one or more security services each being hosted on a cloud platform. Implementations include actions of receiving a request for security services, the request being received from the enterprise operator and including requirements and cost constraints that are to be met by the security services, processing the requirements and cost constraints of the request in view of functions and costs associated with one or more registered security services to identify one or more candidate security services, and providing one or more recommendations to the enterprise operator, each recommendations identifying a candidate security service that can be consumed by the enterprise operator.

### BACKGROUND

Enterprises increasingly conduct business over distributed information technology (IT) systems. For example, an enterprise can offer a computer-implemented service (e.g., a web service) that is hosted on a platform (e.g., a cloud platform). End users, such as customers and/or other enterprises, can access the service. Such computer-implemented services, however, include aspects of risk. For example, a service can be attacked (e.g., by a malicious user) resulting a shutdown or interruption of user access to the service. As another example, data flow between the user and the service might be susceptible to interception by malicious users. Each risk, if realized, impacts the business of the enterprise. Security has often been identified as one of the most critical challenges and hindrances to making cloud computing and distributed business web environments a common utility

### SUMMARY

Implementations of the present disclosure include methods, systems, and computer-readable storage mediums for recommending one or more security services to be consumed by an enterprise operator, the one or more security services each being hosted on a cloud platform. Implementations include actions of receiving a request for security services, the request being received from the enterprise operator and including requirements and cost constraints that are to be met by the security services, processing the requirements and cost constraints of the request in view of functions and costs associated with one or more registered security services to identify one or more candidate security services, and providing one or more recommendations to the enterprise operator, each recommendations identifying a candidate security service that can be consumed by the enterprise operator.

In some implementations, the requirements identify one or more functions that are to be performed by a security service.

In some implementations, the cost constraints include technical cost constraints and economic cost constraints associated with consumption of a security service.

In some implementations, actions further include receiving registration information for a security service to be deployed on the platform, the registration information providing one or more functions provided by the security service and one or more costs associated with the security service, and registering the security service for consumption on the platform.

In some implementations, the costs associated with a registered security service include one or more technical costs and one or more economic costs.

In some implementations, the costs associated with a registered security service include variable costs and fixed costs.

In some implementations, each cost associated with a registered security service is associated with a function of the registered security service.

In some implementations, processing includes executing a matching routine to identify candidate security services as security services that match the requirements and cost constraints.

In some implementations, each candidate security service includes one or more functions that are specified in the requirements and costs that are less than or equal to the cost constraints.

In some implementations, at least one of the one or more security services is provided by a third party developer.

In some implementations, at least one of the one or more security services is provided by a provider of the cloud platform.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 is a block diagram of an example system architecture in accordance with implementations of the present disclosure.

FIG. 2 depicts an example information flow from the perspective of a third party developer.

FIG. 3 depicts an example information flow from the perspective of an enterprise operator.

FIG. 4 is a flowchart depicting an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are generally directed to using technical context provided by cloud infrastructures and data models of mobile applications and backend services (e.g., web services) to enable stakeholders to economically and automatically reason about the cost of security. More particularly, implementations of the present disclosure provide for registering and matching requirements of a security service with the costs of providing that functionality as well as combining this with an optimizing evaluation engine. Implementations of the present disclosure address emerging security services, such as k-anonymity services, that provide security at a service and data flow-level (e.g., as opposed to traditional cryptographic network-based services). As discussed in further detail herein, implementations of the present disclosure enable understanding and automatic processing of security as part of an economic decision-making process of service providers and service consumers during the entire lifecycle of a security service.

Implementations of the present disclosure will be described in view of an example context. The example context includes one or more computer-implemented services that an enterprise can make available to users (e.g., customers, other enterprises). In some examples, the computer-implemented services can each be provided as one or more computer-executable programs that are hosted on a platform. In some examples, the platform can be an enterprise-provided platform (e.g., one or more servers provided by the enterprise for hosting the computer-implemented services). In some examples, the platform can be a cloud platform provided by a third-party service provider (e.g., the computer-implemented services of the enterprise are hosted on the cloud platform). In some examples, an end user can use a computing device (e.g., a smartphone, a tablet computer, a laptop computer, a desktop computer) that can execute a client-side application (e.g., mobile application). The client-side application can communicate with one or more computer-implemented services (e.g., hosted on a platform of an enterprise and/or on a cloud platform). The computer-implemented services can receive data from the computing device and/or from other sources (e.g., databases, other computer-implemented services) and can provide data (e.g., a response) to the computing device.

In general, complex business web environments reflect fine-grained relationships between platform providers, independent software vendors, and customers of cloud-based services. All of these stakeholders expose different behavior and incentives when it comes to providing, combining, or using security related functionality. Customer-provider relationships can be based on economic principles (e.g., customers choose to pay for a service because it is cheaper than doing it themselves). Implementations of the present disclosure address current deficiencies in explaining economic principles guiding the service provider in potentially offering security services, beyond those that may be considered part of the usual due care.

As an example, a computer-implemented service can include a promotional offer management service in the retail domain. In some examples, a retail enterprise can provide promotional offers to end users (e.g., customers). In some examples, the promotional offer management system can receive and/or access customer data to identify one or more promotional offers that may be relevant to a respective customer. As another example, a computer-implemented service can include an invoice approval service in a business domain (e.g., accounting). In some examples, the invoice approval service can be based on a defined business process and can receive and/or access business data to approve/disapprove payment of an invoice. As still another example, a computer-implemented service can include a healthcare service in a medical domain. For example, a healthcare service can provide personal health coaching. In some examples, the healthcare service can receive and/or access medical information associated with a particular user and can provide healthcare coaching to the user.

In some examples, computer-implemented services can access one or more other computer-implemented services provided by other service providers (e.g., other enterprises). For example, a specialized analytics service provider can offer its services to customers (e.g., retailers or healthcare providers) using a cloud platform. The analytics service provider can see a certain incentive in offering either specific additional security services (e.g., anonymization of the analyzed data) or in offering its analytics services in combination with security services offered by the cloud platform. In short, the service provider can strive to increase consumption of its analytics service by offering additional security features.

With reference to the example promotional offer management service above, analytics services can support high-volume real-time analysis of consumer data for real-time promotion offer management in the retail domain. Clients (e.g., large supermarket chains) can consume such services and further propagate functionality to the mobile devices of retail customers, for example. In some examples, such analytics services use aggregated data. In some examples, the aggregated data can be provided on the premises of the retail chain and/or on a hosted platform of the service vendor. In between, data filtering and anonymization services can be invoked.

With reference to the example healthcare service above, personal coaching advice can be generated based on customer (patient) data. For example, clients such as health and wellness providers can use these services to retrieve patient data on physical activities (e.g., from a data store or directly from the patients' mobile devices). Clients can also use some analysis functions provided by an analytics service. Because patient information is extremely sensitive, some form of controlled and secure access to the patient data or to information that can be derived from the patient data can be provided. This can require a service developer or operator to cater for the integration of advanced security services on data.

Example security services can include a sanitizable signature service and a k-anonymity service. In some examples, a sanitizable signature service provides a sanitizable signature scheme (SSS) that enables a defined third party (the so-called sanitizer) to alter an already signed document without invalidating the signature and without involving the original signer again. Such a service could be used in the context of a cloud solution that supports complex retail buyer/supplier processes to enable changes to signed bills of lading or purchase orders, for example. One example of a requirement on such an extended signature service can be to which degree it supports signer and sanitizer accountability. Another business requirement on such a service can be whether it supports restriction to values (e.g., a sanitizer is just able to replace a sub-document with certain preset values instead of values of their own choice. From a cost perspective, the technical cost for setting up and distributing cryptographic keys to all partners involved in a retail supply chain can be considered.

In some examples, a k-anonymity service can provide protection of a micro-data table with respect to possible re-identification of the respondents to which the data refer. In some examples, this can be offered as a security service that acts as a filter when data is flowing between different services. One quality requirement on such a k-anonymity service can include the degree of information loss of a k-anonymized data set. An operational and cost-related variable can include the required computation of the k-anonymized data set.

Although implementations of the present disclosure are discussed herein with reference to the example context and example services described above, it is appreciated that implementations are applicable in other contexts and other services.

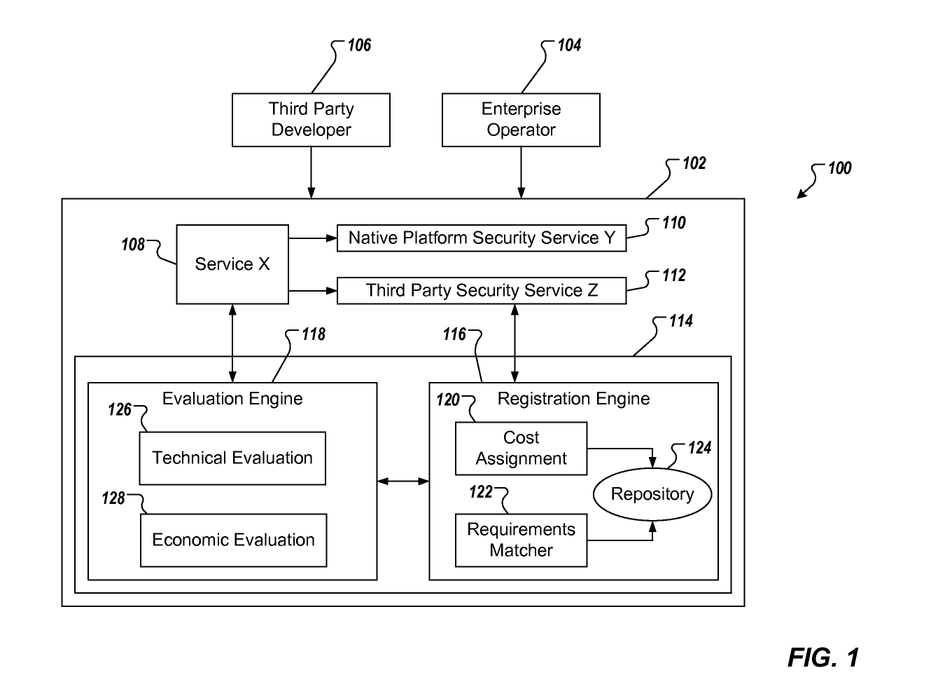

FIG. 1 depicts an example system architecture 100 in accordance with implementations of the present disclosure. In some implementations, the example system architecture 100 can include a platform 102, an enterprise operator 104 and a third party developer 106. In some implementations, the platform 102 can be provided using one or more computing devices (e.g., server computing devices). In some examples, the platform 102 can be an enterprise-provided platform (e.g., one or more servers provided by the enterprise operator for hosting computer-implemented services). In some examples, the platform 102 can be a cloud platform provided by a platform service provider (e.g., one or more servers provided by the platform service provider for hosting computer-implemented services). In some examples, the platform 102 can be provided as a combination of an enterprise-provided platform and a cloud platform. In some examples, one or more server computing devices can execute one or more computer program applications to provide the platform 102.

As discussed in further detail herein, the third party developer 106 can communicate with the platform 102 to provide one or more security services that can be hosted on the platform 102. Further, the enterprise operator 102 can communicate with the platform 102 to consume one or more services (e.g., business services) and/or one or more security services hosted on the platform 102. In some implementations, the enterprise operator 104 and the third party developer 106 each communicate with the platform 102 over a network (e.g., a local area network (LAN), a wide area network (WAN), the Internet, a cellular network, a telephone network (e.g., PSTN) or an appropriate combination thereof connecting any number of communication devices, mobile computing devices, fixed computing devices and/or server systems).

In some implementations, the platform 102 is provided as an abstract cloud platform the enables third party developers, such as the third party developer 106, to develop and host applications (e.g., business services and/or security services). In some examples, the platform 102 further enables enterprise operators, such as the enterprise operator 104, to subscribe to one or more applications. In some examples, enterprise operators can offer functionality provided by the application as a solution to end-consumers. In accordance with implementations of the present disclosure, the platform 102 offers an economic decision making functionality that enables third party developers and enterprise operators to decide what security services are available as well as what dimensions of cost (both technical and economic) are associated with the security services.

In the depicted example, the platform 102 includes a service 108, security services 110, 112 and a security service management system 114. The security service management system includes a registration engine 116 and an evaluation engine 118. In some examples, the service 108 is provided as one or more computer-executable programs that are hosted on the platform 102. For example, the service 108 can be provided as an application that is developed by a developer (not shown) or the third party developer 106. In some examples, the service 108 can include any appropriate application that will provide business functionality and can be hosted in a cloud platform. In some examples, the security services 110, 112 can each be provided as one or more computer-executable programs that are executed on the platform 102. In the depicted example, the security services include a native platform security service 110 (e.g., provided by the platform operator) and a third party developer security service 112 (e.g., provided by a third party developer). In some examples, security services 110, 112 can include any appropriate service that provides security functionality. Example security functionality can include data pseudonymization (e.g., replacing data items that may be personally identifiable information with pseudonyms), access control and privacy services, k-anonymity, sanitizable digital signatures, and the like.

In some examples, the registration engine 116 can be provided as one or more computer-executable programs that are executed on the platform 102. In the depicted example, the registration engine 116 includes a cost assignment module 120, a requirements matcher module 122 and a repository 124. In some examples, the registration engine 116 enables the platform provider and/or third party developers to register security services with the platform 102 and to associate costs of consuming such security services (e.g., using the cost assignment module 120). In some examples, the registration engine 116 enables enterprise operators to express and register their security requirements.

In some examples, the evaluation engine 116 can be provided as one or more computer-executable programs that are executed on the platform 102. In the depicted example, the evaluation engine 116 includes a technical evaluation module 126 and an economic evaluation module 128. In some examples, the evaluation engine 116 provides automated suggestions about the different dimensions of cost and benefit, if an application (e.g., the service) requires security functionality that could be procured from several service providers.

In accordance with implementations of the present disclosure, a security service is provided and is deployed on a cloud platform. For example, the security service can be developed by the platform operator (e.g., the security service 110 of FIG. 1). As another example, the security service can be developed by a third party developer (e.g., the security service 112 of FIG. 1). In some examples, the security service is deployed on the platform by uploading the security service to the platform and making the security service available for use (e.g., for use by the enterprise operator 104 of FIG. 1). In some examples, and as part of the deployment process, the service developer (e.g., the platform operator or the third party developer) provides the technical security functionality that is included with the security service, as well as the associated costs. For example, the security service can include an anonymization service that provides anonymity for consumer records (e.g., anonymizes data). The security service, however, will incur some technical costs (e.g., overhead in data storage size, latency) and economic costs (e.g., monetary value based on transaction and/or data volume).

An application (e.g., the service 108 of FIG. 1) is also deployed on the platform and is consumed by one or more enterprise operators (e.g., the enterprise operator 104 of FIG. 1). Continuing with the example context above, the application can include a mobile retail application that is consumed by one or more retail chains (e.g., supermarkets).

A distinction can be made between the third party developer that reasons about some make or buy decisions, and an enterprise operator that reasons about what additional security services to consume. The articulated (service provider) and expressed (service consumer) requirements as well as associated costs are stored in the registration engine, which reconciles this data with optimization functionality provided by the evaluation engine (discussed below). In some examples, and based on the optimization, the service consumes exactly the required and available security functionality at a specific technical cost and monetary cost.

By way of example, the service can include a retail engine provided by a third party developer. The third party developer can know that the retailing engine requires security that includes k-anonymization functionality when receiving bulk data from backend, on-premise systems. The third party developer, however, might be unsure whether to develop the security itself or to consume another specialized service that provides the security. Ultimately, this question can be based on the production and maintenance costs of such a service as well as the expected revenue.

An enterprise operator will face a similar question. The enterprise operator might want to offer the retail service to customers, but due to legal and country specific guidelines, for example, any consumer data must be anonymized. In some examples, an internal service can already be available on the enterprise operator side that offers the security functionality. This can be in addition to a security service offered by the third party developer on the platform. The question now is which service the enterprise operator should bind into its overall precision retailing solution.

Implementations of the present disclosure further provide a multi-step approach for the calculation of the costs and solution space. In some examples, the developer of the security service (e.g., the third party developer, the platform provider) describes the technical and economic costs associated with the service; the consumer of the security service (e.g., an enterprise operator) states their security requirements and existing upfront cost constraints (e.g., technical and economic); the registration engine matches consumer requirements and costs constraints with functionality and cost models of registered security services; and the evaluation engine computes the solution space to recommend one or more security services.

In further detail, a security service s can be defined by the tuple s (id, func (f1, . . . fn), tc(fx, fc( ), vc( ), ec(fx, fc( ), vc( ))), where s is associated with an identifier id and a list of functionalities func. The tuples tc and ec describe the variable costs vc and fixed costs fc related to each functionality fx of the security service. A requirement req of a potential consumer of the security service can be captured as a tuple of the form req (id, weight), where weight may be used by the service consumer to emphasize the importance of a particular requirement. A security service s can satisfy one or more requirements defined by the example relation satisfies (service, (req (1), . . . req(n)).

In some examples, existing cost constraints can be expressed by the a tuple cons (req, tcc(c(x)), ecc(c(y))), which describes any articulated technical cost constraints tcc or economic cost constraints ecc, expressed by a cost function c(x), c(y), respectively, which can take the form of a scalar or set of discrete or linear values. In some examples, the matching function match (s(id), req(id)) can be abstracted as iterating over all available security service and the associated functional requirements of a service consumer and costs constraints as well as matching these with the provided security service descriptions. An example matching function can be provided as:

$$match ( s ( id ) , req ( id ) ) = {\sum }_{{s}_{x} ∈ S}^{ } {\sum }_{{req}_{y} ∈ {s}_{x}}^{ }$$

where req_{y} is in sₓ(func), tc_{y}≦tcc_{y} and ec_{y}≦ecc_{y}. In some examples, the result of the matching function can include a set of linear equations which can be used as input to the evaluation engine to compute the solution space and set of optima using, for example, standard SIMPLEX algorithms. However, other optimization approaches from the field of linear programming as well as other mathematical domains such as game theory could be used. Based on the above steps, one or more security services can be recommended to an enterprise operator. The enterprise operator can select a security service to use with some other service (e.g., a business service) that the enterprise operator consumes.

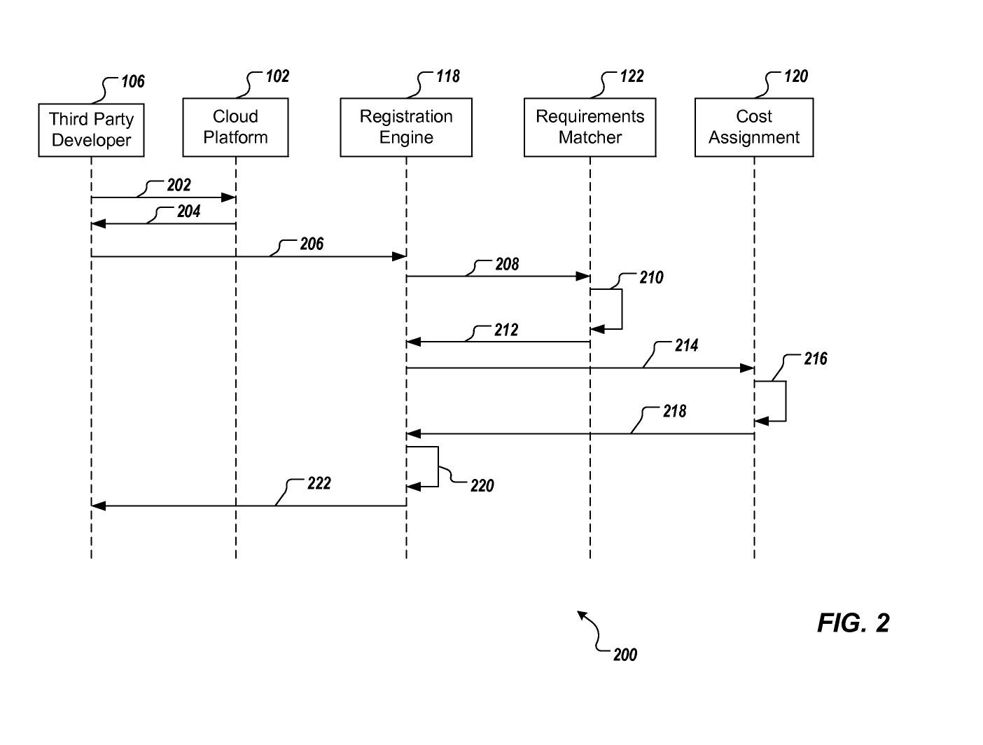

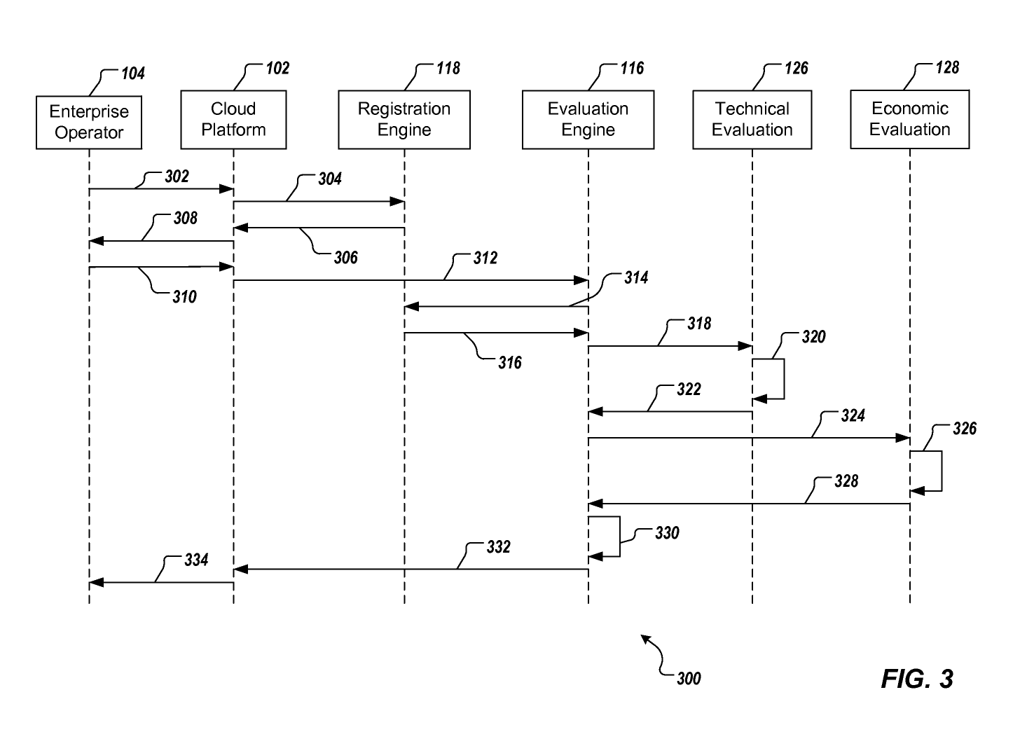

Referring now to FIGS. 2 and 3, implementations of the present disclosure are described in further detail with respect to the interaction of example components, as depicted in FIG. 1, from the perspective of a third party developer (e.g., the third party developer 106 of FIG. 1) that offers a security service, and an enterprise operator (e.g., the enterprise operator 104 of FIG. 1) that consumes a security service.

FIG. 2 depicts an example information flow 200 from the perspective of the third party developer 106. In some examples, when the third party developer 106 wants to offer a security service (e.g., the security service 112) using the cloud platform 102, the third party developer 106 registers the security service with the platform 102. In some examples, the third party developer 106 registers security functionality and associated costs (technical and economic) of the security service. As depicted in FIG. 2, the third party developer 106 can send a message 202 to the platform 102 to initiate deployment and registration of the security service. In response, the platform 102 provides a message 204 that includes registration requirements for the security service. The third party developer 106 sends a message 206 that includes the requested registration information. In the depicted example, the message 206 is received and processed by the registration engine 118 to register the security service.

In some implementations, a service specification provided in the message 206 can be matched with respect to general security requirements. For example, the requirements matcher module 122 can receive the functionality description of the security service in a message 208, and can perform a requirements matching routine 210. In some examples, matching can be performed based on a service description language (e.g., the uniform service description language (USDL) and extensions (e.g., USDL-SEC) that describe security functionality of a service. In some examples, the requirements matcher 122 matches such technical descriptions of security functionality with a set of domain independent requirements and/or domain dependent requirements. For example, an anonymization requirement for purchase order data in the automotive industry is different to an anonymization requirement for customer records in the retail domain. A result of the requirements matching routine 210 can be provided to the registration engine 118 in a message 212.

Further, a message 214 can be provided to the cost assignment module 120. In some examples, the message 114 can include costs (technical and/or economic) associated with consuming some or all functionality of the service. In some examples, the cost assignment module 120 performs a cost assignment routine 216 to assign different types of cost with different consumption modes of the security service. A result of the cost assignment routine 216 can be provided to the registration engine 118 in a message 212. The data provided in the messages 212, 218 can be processed by the registration engine 212 in a routine 220. In some examples, the registration engine 118 reconciles the results provided in the messages 212, 218, and can publish a specification of all supported consumption modes where it was able to match requirements and calculate associated costs. The specification can be provided to the third party developer in a message 222. In some examples, the third party developer can make the specification part of a description (e.g., service description) and execution of the security service.

FIG. 3 depicts an example information flow 300 from the perspective of the enterprise operator 104. As a result of one or more iterations of the example information flow 200, one or more security services and their associated costs have been described by one or more third party service developer(s) and can be consumed in the platform 102. By way of example, the enterprise operator 104 can be looking for a specific k-anonymity service to use in the context of a precision retail solution. As an example, three different k-anonymity security services can be available on the platform 102, each security service differing in variable and fixed costs as well as specific quality aspects (e.g., the degree of information loss or required time to perform the anonymization on a dataset of a specific size).

In the depicted example, the enterprise operator 104 can send a message 302 to query the platform 102 for all available security services in a specific category (e.g., k-anonymity). In some examples, a standard marketplace and brokering functionality can be available, as well as a service description language (e.g., USDL and its security extension). The platform 102 can provide a message 304 to pass the request to the registration engine 118. The registration engine 118 can process the request and can generate a result that is provided in a massage 306, which result can be provided back to the enterprise operator 104 in a message 310. In some examples, the enterprise operator 104 can provide a message 310 that includes more specific selection criteria (e.g., the k-anonymity security service should guarantee <2.5% data loss, have a maximum fixed costs of X units, should not exceed variable costs of Y units per transaction). The additional selection criteria can be provided to the evaluation engine 116 in a message 312. In some examples, and based on the additional selection criteria, the evaluation engine 116 can perform another reconciliation (e.g., match of requirements and registered functionality) with the registration engine 118 (e.g., including an exchange of messages 314, 316).

In some implementations, calculation of the technical costs and economic costs is performed and results are returned. In the depicted example, the evaluation engine 116 can provide a message 318 that includes technical cost constraints to the technical evaluation module 126. The technical evaluation module 126 can perform a calculation of technical costs 320 and can provide a technical cost result in a message 322. In the depicted example, the evaluation engine 116 can provide a message 324 that includes economic cost constraints to the economic evaluation module 128. The economic evaluation module 128 can perform a calculation of economic costs 326 and can provide an economic cost result in a message 328. In some examples, results can each be provided as a linear program that is included in the messages 322, 328, respectively, to the evaluation engine 116. Based on the results, the evaluation engine 116 compute the overall solution space 330, which can include technical and economic costs as well as requirements for all available security services. In some examples, the evaluation engine 128 determines one or more optima within the solution space, which optima can include one or more of the available security services. That is, the identified one or more security services can be provided as suggestions to the enterprise operator. In some examples, the entire problem for the enterprise operator 104 to determine which security service best fits its needs can be broken down into a linear optimization problem, for which algorithms (e.g., SIMPLEX) can be processed by the evaluation engine 116. The results are fed back to the enterprise operator in a message 334.

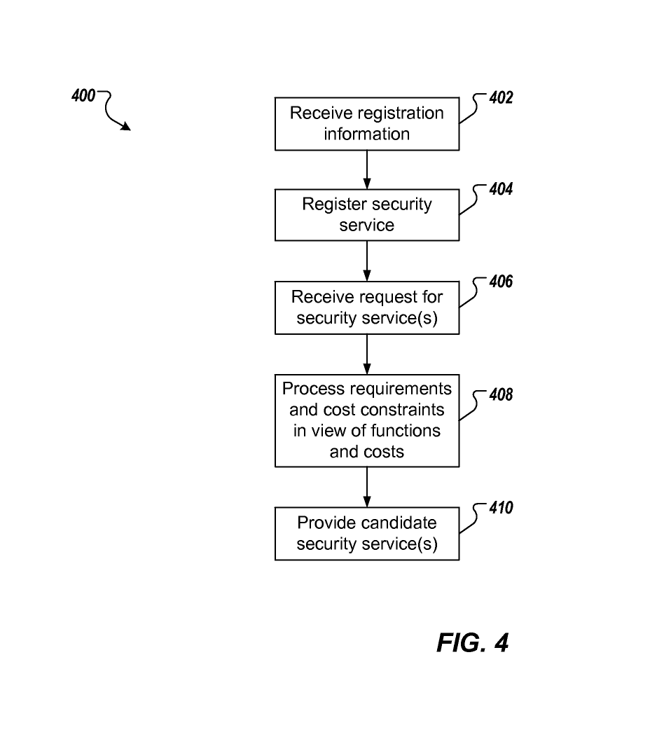

FIG. 4 is a flowchart depicting an example process 400 that can be executed in accordance with implementations of the present disclosure. In some implementations, the example process 400 can be implemented using one or more computer-executable programs that can be executed using one or more processors. For example, the example process 400 can be executed within the cloud platform 102 of FIG. 1.

Registration information for a security service to be deployed on the platform is received (402). In some examples, the registration information includes one or more functions provided by the security service and one or more costs associated with the security service. The security service is registered for consumption on the platform (404).

A request for security services is received (406). In some examples, the request is received from an enterprise operator and includes requirements and cost constraints that are to be met by the security services. The requirements and cost constraints of the request are processed in view of functions and costs associated with one or more registered security services to identify one or more candidate security services (408). For example, requirements and cost constraints are matched to functions and costs associated with registered security services do identify candidate security services that meet the needs of the enterprise operator. One or more recommendations are provided to the enterprise operator (410). In some examples, each recommendation identifies a candidate security service that can be consumed by the enterprise operator. In some examples, the enterprise operator can consume a candidate security service (e.g., use the security service in conjunction with one or more other services).

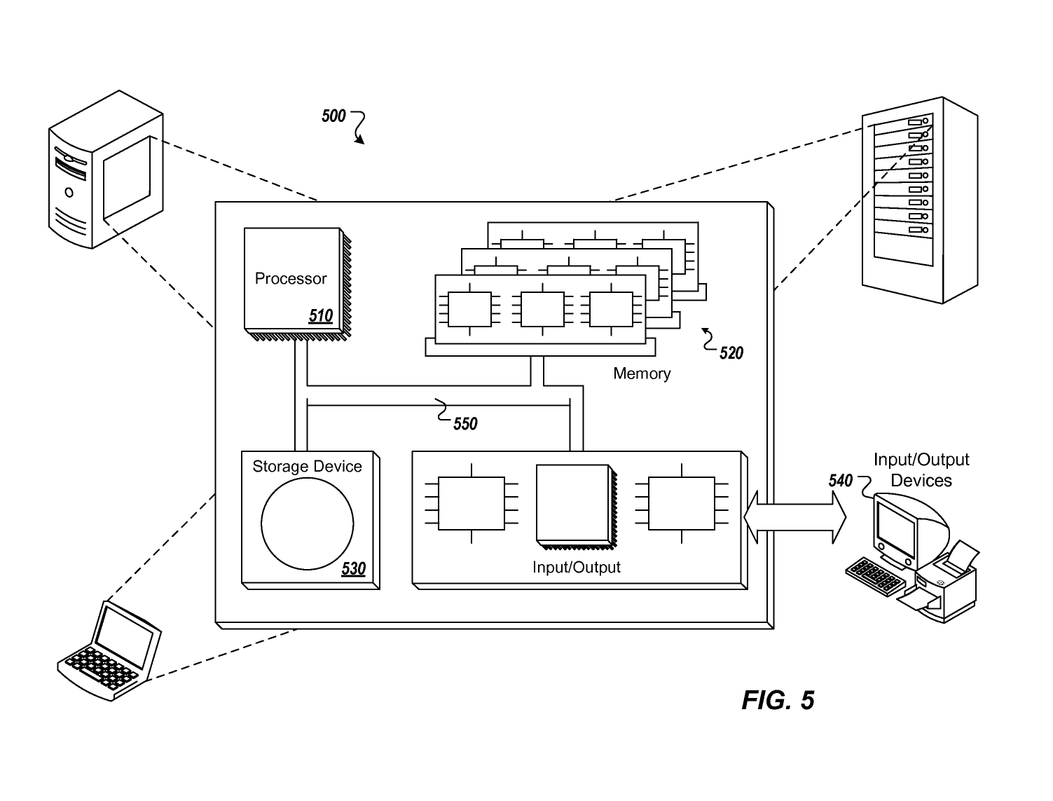

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for recommending one or more security services to be consumed by an enterprise operator, the one or more security services each being hosted on a cloud platform, the method being executed using one or more processors and comprising:
receiving, by the one or more processors, a request for security services, the request being received from the enterprise operator and comprising requirements and cost constraints that are to be met by the security services;
processing, by the one or more processors, the requirements and cost constraints of the request in view of functions and costs associated with one or more registered security services to identify one or more candidate security services; and
providing one or more recommendations to the enterprise operator, each recommendations identifying a candidate security service that can be consumed by the enterprise operator.

2. The method of claim 1, wherein the requirements identify one or more functions that are to be performed by a security service.

3. The method of claim 1, wherein the cost constraints comprise technical cost constraints and economic cost constraints associated with consumption of a security service.

4. The method of claim 1, further comprising:
receiving registration information for a security service to be deployed on the platform, the registration information providing one or more functions provided by the security service and one or more costs associated with the security service; and
registering the security service for consumption on the platform.

5. The method of claim 1, wherein the costs associated with a registered security service comprise one or more technical costs and one or more economic costs.

6. The method of claim 1, wherein the costs associated with a registered security service comprise variable costs and fixed costs.

7. The method of claim 1, wherein each cost associated with a registered security service is associated with a function of the registered security service.

8. The method of claim 1, wherein processing comprises executing, by the one or more processors, a matching routine to identify candidate security services as security services that match the requirements and cost constraints.

9. The method of claim 1, wherein each candidate security service includes one or more functions that are specified in the requirements and costs that are less than or equal to the cost constraints.

10. The method of claim 1, wherein at least one of the one or more security services is provided by a third party developer.

11. The method of claim 1, wherein at least one of the one or more security services is provided by a provider of the cloud platform.

12. A non-transitory computer-readable storage medium coupled to one or more processors and having instructions stored thereon which, when executed by the one or more processors, cause the one or more processors to perform operations for recommending one or more security services to be consumed by an enterprise operator, the one or more security services each being hosted on a cloud platform, the operations comprising:
receiving a request for security services, the request being received from the enterprise operator and comprising requirements and cost constraints that are to be met by the security services;
processing the requirements and cost constraints of the request in view of functions and costs associated with one or more registered security services to identify one or more candidate security services; and
providing one or more recommendations to the enterprise operator, each recommendations identifying a candidate security service that can be consumed by the enterprise operator.

13. A system, comprising:
a computing device; and
a computer-readable storage device coupled to the computing device and having instructions stored thereon which, when executed by the computing device, cause the computing device to perform operations for recommending one or more security services to be consumed by an enterprise operator, the one or more security services each being hosted on a cloud platform, the operations comprising:
receiving a request for security services, the request being received from the enterprise operator and comprising requirements and cost constraints that are to be met by the security services;
processing the requirements and cost constraints of the request in view of functions and costs associated with one or more registered security services to identify one or more candidate security services; and
providing one or more recommendations to the enterprise operator, each recommendations identifying a candidate security service that can be consumed by the enterprise operator.
